(19) United States
(12) Patent Application Publication
(10) Pub. No.: US 2007/0041032 A1
(43) Pub. Date: Feb. 22, 2007

(54) Image reading apparatus and control method therefor

(75) Inventors: Hideaki Sugimoto, Saitama (JP); Katsuo Shimizu, Saitama (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/330,193

(22) Filed: Jan. 12, 2006

(30) Foreign Application Priority Data
Aug. 19, 2005 (JP) 2005-238396

(51) Int. Cl. G06K 15/00

(52) U.S. Cl. 358/1.14; 358/1.15

(57) ABSTRACT

An image reading apparatus that reads an original document and transmits image data to a printing apparatus after writing the image data in a predetermined page description language, wherein the image reading apparatus reads the image data from the original document on a line-by-line basis; performs pattern recognition at the same time with the storing of the image data in a buffer; detects a copy-prohibited image by a matching processor; starts transmitting the image data to the printing apparatus upon completion of the storing of the image data of a predetermined number of lines in the buffer; and, when the copy-prohibited image is detected by the matching processor, discontinues the transmission processing, while simultaneously instructing to discontinue the print processing.

### BACKGROUND OF THE INVENTION

1. Field of the Invention

The present invention relates to an image reading apparatus and a control method therefor. Particularly, the present invention relates to an image reading apparatus that is designed such that image data read from an original document can be transmitted rapidly from the image reading apparatus by storing the image data read from the original document while simultaneously detecting any copy-prohibited image, and relates to a control method for such image reading apparatus.

2. Description of the Related Art

In recent years, prices of office automation (OA) equipment such as copying machines and multi-function copiers have been going down significantly, and hardware makers who provide customers with such OA equipment are required to take measures to cope with this trend.

There has been proposed a scanner/printer system (print system) which is provided with both a scanner and a printer and designed to perform various types of print processing including copy processing by cooperation of the scanner and the printer.

Such print system is advantageous in being capable of performing print processing including copy processing with simple configuration. Additionally, the cost for introduction of such print system can be suppressed significantly more than the cost for introduction of a multi-function copier or a copying machine.

Typically, in print systems for performing print processing including copy processing, pattern recognition is performed on scanned image in order to prohibit copy processing of a specific image.

A description will be made of a sequence of print processing steps performed by this type of print system, with reference to FIG. 10. The following description will be made in terms of a case in which the printer is a laser printer.

On the scanner side, when an original document to be scanned is set and a start button is pressed, scan processing of the original document is started. Upon the start of the scan processing, image data is read from the original document on a line-by-line basis, and sequentially stored in a buffer. When the scan processing is completed and image data of one page has been stored, pattern recognition is conducted on the stored image data. If no copy-prohibited image is detected and no violation is found, the scanner starts transmitting the image data to the printer.

On the printer side, a printer controller receives the image data transmitted from the scanner, while simultaneously storing the data in a buffer. When image data of one page has been stored, an activation request is transmitted to an engine.

Upon receiving the activation request, the engine is triggered by the request to start print preparation. For example, the engine starts energizing a heater to heat a fuser unit up to a specific temperature or higher so that the printer is shifted to a state in which printing is possible.

Upon transmitting the activation request to the engine, the printer controller becomes standby until a predetermined time (print preparation time) has passed. After the standby, the printer controller starts transferring the image data when the engine has completed print preparation. Receiving the transferred image data, the engine starts print processing by forming an image on a paper sheet based on the image data. The processing terminates upon completion of the printing.

A conventionally known technique relating to pattern recognition done on the scanner side is described in Japanese Patent Application Publication 2002-044434. According to the technique of this patent publication, pattern recognition is performed for every predetermined number of lines so that copy-prohibited images such as those of securities or banknotes can be detected quickly.

In the conventional print system as described above, the scanner starts transmission of image data only after image data corresponding to one page of the original document has completely been stored. This measure is taken so that pattern recognition is performed to match the original document up to the end thereof against a specific image and, if there is found a match, the data is treated as an error and not transmitted.

Accordingly, the conventional technique poses a problem that the pattern recognition will delay the start of transmission of image data and deteriorate the throughput according to the delay.

### SUMMARY OF THE INVENTION

The present invention has been made in view of the above circumstances and provides an image reading apparatus that is capable of rapidly transmitting image data from the image reading apparatus while effectively preventing a copy-prohibited image from being copied, and a control method for such image reading apparatus.

According to an aspect of the present invention, an image reading apparatus that reads image data from an original document and transmits the read image data to a printing apparatus after writing the same in a predetermined page description language, comprises an image reader that reads image data from the original document on a line-by-line basis; a buffer that stores the image data read by the image reader sequentially on a line-by-line basis; a matching processor that performs pattern recognition at the same time with the storing of the image data in the buffer to detect a copy-prohibited image; a transmission controller that starts transmitting the image data to the printing apparatus upon completion of the storing of the image data of a predetermined number of lines in the buffer; an abnormality processor that, when the copy-prohibited image is detected by the matching processor, discontinues the transmission processing by the transmission controller, while simultaneously instructing the printing apparatus to discontinue the print processing for the copy-prohibited image.

### BRIEF DESCRIPTION OF THE DRAWINGS

Embodiments of the present invention will be described in detail based on the following figures, wherein:

FIG. 1 is a block diagram showing an example of overall configuration of a print system provided with an image reading apparatus according to the present invention;

FIG. 2 is a block diagram showing an example of internal configuration of the scanner 10 shown in FIG. 1;

FIG. 3 is a block diagram showing a part of functional configuration of the scanner controller 14 shown in FIG. 2;

FIG. 4 is a diagram showing an example of structure of print data;

FIG. 5 is a block diagram showing an example of internal configuration of the printer 20 shown in FIG. 1;

FIG. 6 is a block diagram showing a part of functional configuration of the printer controller 24 shown in FIG. 5;

FIG. 7 is a sequence chart diagram showing an example of processing steps performed by the print system shown in FIG. 1;

FIG. 8 is a flowchart showing an example of operation of the scanner 10 shown in FIG. 1;

FIG. 9 is a flowchart showing an example of operation of the printer 20 shown in FIG. 1; and

FIG. 10 is a sequence chart diagram showing print processing steps performed by a conventional scanner and printer.

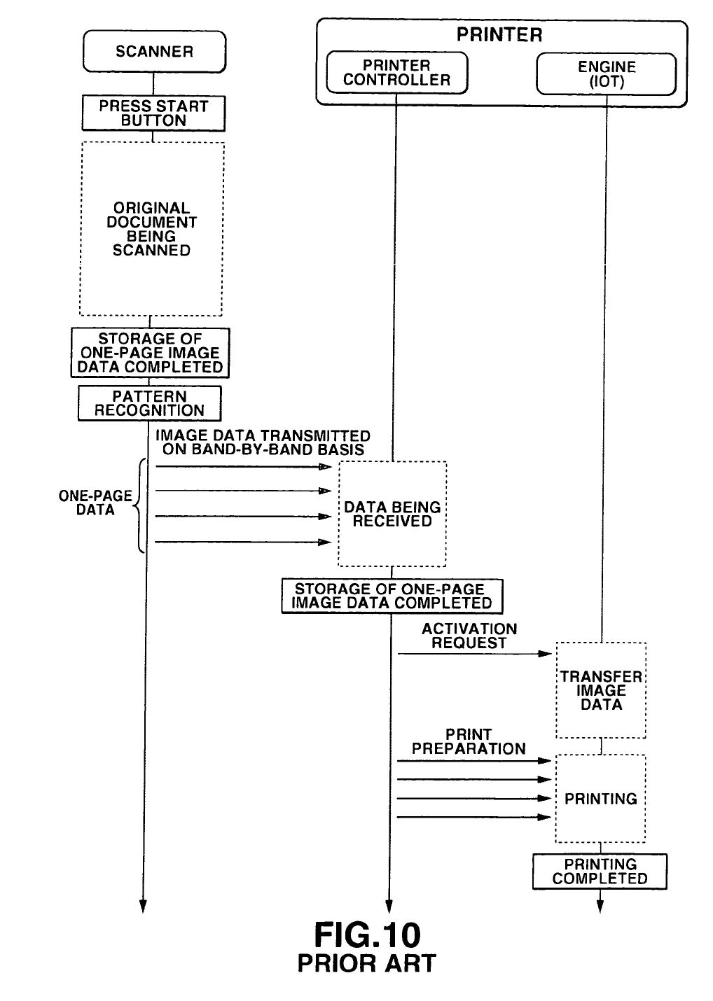

### DETAILED DESCRIPTION OF THE INVENTION

A detailed description will now be made, with reference to the attached drawings, of embodiment of a print system and a control method therefor according to the present invention.

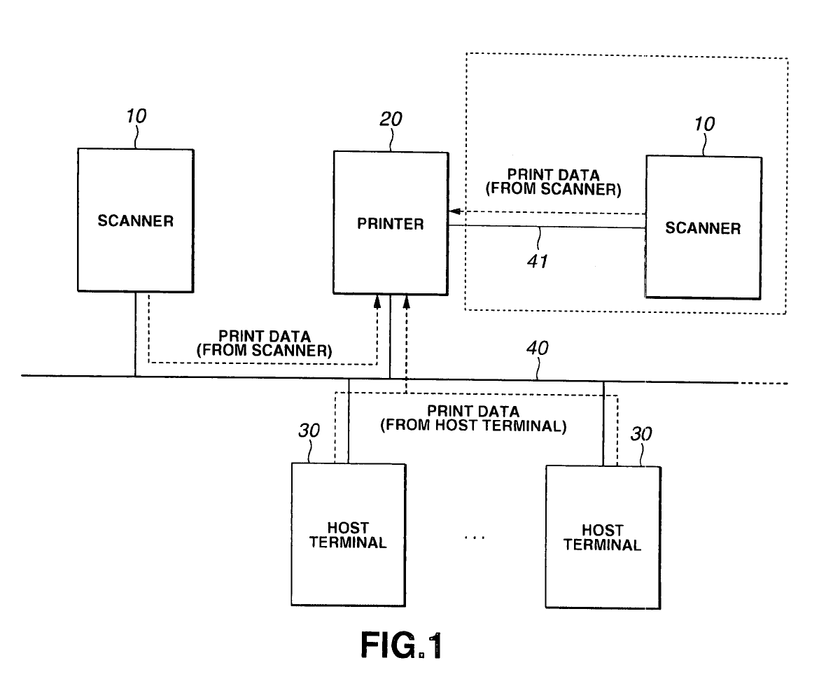

FIG. 1 is a block diagram showing an example of overall configuration of a print system provided with an image reading apparatus according to the present invention. The following description of an embodiment will be made in terms on a case in which an image reading apparatus according to the present invention is applied to a scanner 10.

The print system includes a scanner 10, a printer 20, and one or plural host terminals 30, which are connected together via a network such as a LAN (Local Area Network) 40.

The following description of this embodiment will be made in terms of the case where the scanner 10 is connected to the printer 20 via the LAN 40. However, the scanner 10 and the printer 20 may be connected by any other means as long as they are able to communicate with each other. For example, as shown in the dotted frame in FIG. 1, the scanner 10 may be connected directly to the printer 20 by means of a USB (Universal Serial Bus) or Centronics interface 41.

The scanner 10 is an image reading apparatus which reads graphics, photographs, or characters by scanning an original document that is placed or conveyed on a platen glass, and converts them into digital data.

The scanner 10 reads image data from an original document line by line (hereafter, to be referred to as the “line data”), and stores the same in a buffer (scanner buffer 13 to be described later). Once image data of one band (corresponding to a predetermined number of lines) has been stored in the buffer, the scanner 10 generates print data by writing the data in a predetermined page description language, and transmits the print data to the printer 20.

Thereafter, every time image data of one band is stored in the buffer, the scanner 10 generates print data and transmits the generated data to the printer 20.

The scanner 10 performs pattern recognition at the same time with the storage of the data in the buffer. If the pattern recognition detects any copy-prohibited image, the scanner 10 discontinues the transmission of the print data while simultaneously transmitting a termination command to the printer 20 to discontinue the print processing of the printer 20.

The printer 20 is a laser printer using laser light (laser-type printing apparatus). Upon receiving print data from the scanner 10 or the host terminal 30, the printer 20 interprets the page description language in the print data and executes print processing. A copy function can be performed by the printer 20 cooperating with the scanner 10 so that image data read by the scanner 10 is printed out by the printer 20.

Upon receiving print data from the scanner 10, the printer 20 extracts (or deployed) the image data stored in the print data on a band-by-band basis, and stores the data in a buffer (printer buffer 22 described later). Once image data of one page has been stored in the buffer, the printer 20 activates the engine to start print processing for the print data.

The host terminal 30 is, for example, a personal computer operated by a user. One or plural such host terminals 30 are connected on a LAN 40. Through the host terminal 30, the user is able to select a desired file (data to be printed) and request the printer 20 to print the same.

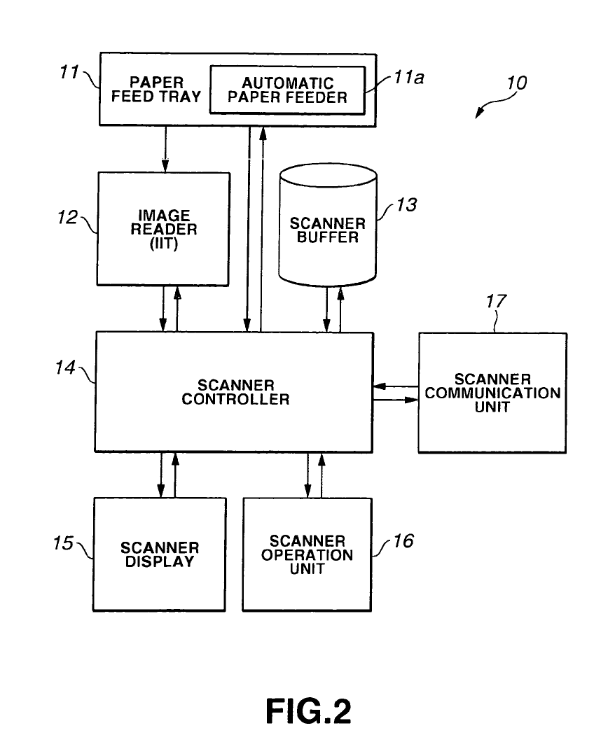

FIG. 2 is a block diagram showing an example of internal configuration of the scanner 10 shown in FIG. 1.

The scanner 10 includes a paper feed tray 11 to place an original document to be scanned, an image reader 12, a scanner buffer 13, a scanner controller 14, a scanner display 15, a scanner operation unit 16, and a scanner communication unit 17. The image reader 12 is an image input terminal (IIT) which includes an illumination lamp, a lens, and a CCD (Charge Coupled Device) and scans the original document placed on the paper feed tray 11 to read image data on a line-by-line basis. The scanner buffer 13 is formed by a random access memory (RAM) or the like to temporally store image data read by the image reader 12. The scanner controller 14 is composed of a central processor (CPU) and various application specific integrated circuits (ASICs) and integrally controls the scanner 10. The scanner display 15 is a display device such as a liquid crystal display. The scanner operation unit 16 is an input device such as an operation button. The scanner communication unit 17 is a communication interface device which is composed of a network card, a USB port and the like to connect between the scanner 10 and other apparatuses (e.g., the printer 20 and the host terminals 30).

The paper feed tray 11 is provided with an automatic paper feeder 11a so that, when the original document placed on the tray is composed of several sheets of paper, these paper sheets are sequentially fed one by one by the automatic paper feeder 11a, and conveyed to a paper discharge tray (not shown) via a platen glass (not shown).

The image reader 12 scans the original document that is conveyed on the platen glass by the automatic paper feeder 11a to read the original document image data. By repeating this operation, the sheets of the original document placed on the paper feed tray 11 can be read consecutively.

The scanner buffer 13 sequentially stores the image data read by the image reader 12 on a line-by-line basis. As mentioned before, once image data of one band has been stored, the data is transmitted to the printer 20. Therefore, the scanner buffer 13 only need be able to store image data of one band.

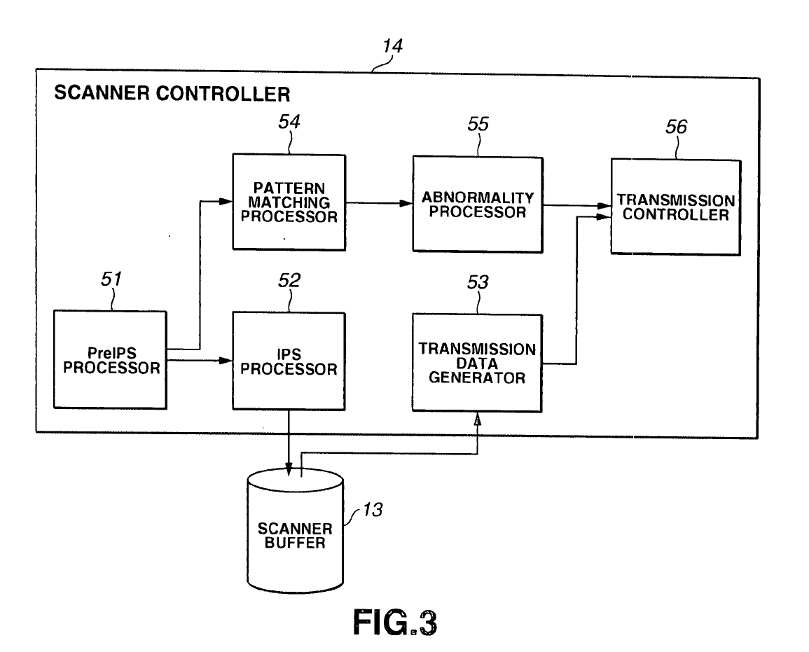

A description will now be made, with reference to FIG. 3, on a part of functional configuration of the scanner controller 14.

The scanner controller 14 includes, as various processing functions, a PreIPS processor 51, an IPS processor 52, a transmission data generator 53, a pattern matching processor 54, an abnormality processor 55, and a transmission controller 56.

The PreIPS processor 51 performs shading correction or color interpolation on line data input from the image reader 12. The IPS processor 52 performs image edit processing on the image data that has been subjected to a predetermined processing by the PreIPS processor 51, according to print parameters set by the user, and stores the edited data in the scanner buffer 13.

The line data processed and output by the IPS processor 52 is formed by bitmapped image that has been edited according to the print parameters. Therefore, upon receiving the data, the printer 20 is able to directly use this image to perform print processing.

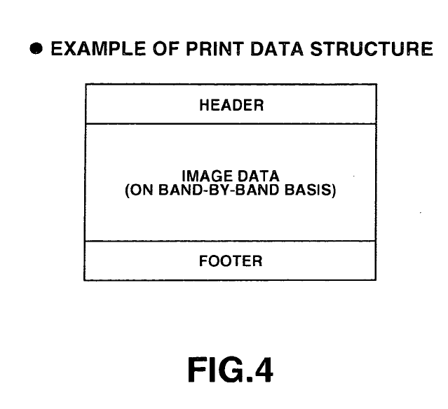

Once image data of one band has been stored in the scanner buffer 13, the transmission data generator 53 acquires the data to generate print data written in a predetermined page description language. The print data generated by the transmission data generator 53 has a structure, for example, as shown in FIG. 4, in which data written in the page description language is added at the beginning and end of the image data (header and footer).

The pattern matching processor 54 performs pattern recognition at every predetermined number of lines to detect any copy-prohibited (unlawful) image. For example, the known technique disclosed in Japanese Patent Application Publication 2002-044434 may be used to detect copy-prohibited images such as those of securities or banknotes.

When the pattern matching processor 54 detects a copy-prohibited image, the abnormality processor 55 abnormally terminates the copy processing that is being executed by the scanner 10 and printer 20. More specifically, the abnormality processor 55 controls the discontinuation of the scan processing and print data transmission processing that are being executed by the scanner 10, while at the same time transmitting a termination code to the printer 20 to indirectly control the discontinuation of the print processing that is being executed by the printer 20. The abnormality processor 55 also displays, on the scanner display 15, a message indicating the abnormality, while simultaneously causing a speaker (not shown) to emit an alarm sound to inform the user of the occurrence of the abnormality.

The transmission controller 56 transmits the print data generated by the transmission data generator 53 to the printer 20 via the scanner communication unit 17. If the transmission controller 56 receives, during the transmission processing, an instruction to discontinue the transmission from the abnormality processor 55, the transmission controller 56 discontinues the transmission processing. The foregoing is the description of the function blocks showing a part of the functional configuration of the scanner controller 14.

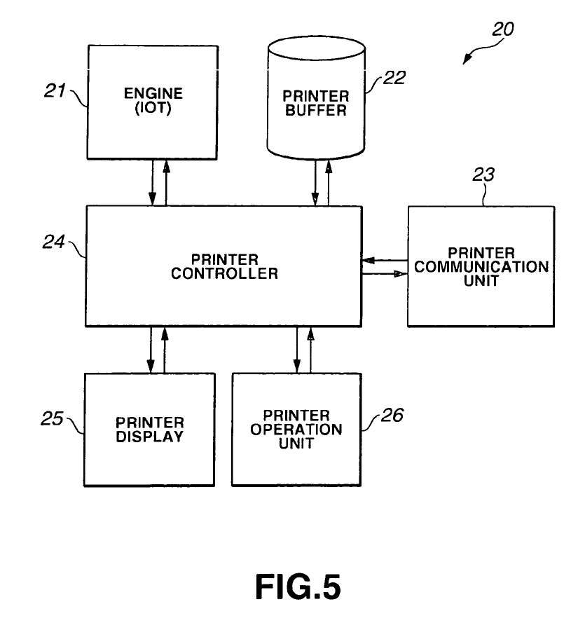

FIG. 5 is a block diagram showing an example of internal configuration of the printer 20 shown in FIG. 1.

The printer 20 includes an engine, or image output terminal (IOT) 21, a printer buffer 22, a printer communication unit 23, a printer controller 24, a printer display 25, and a printer operation unit 26. The engine (IOT) 21 is composed of a photoconductor drum, a transfer belt and the like, and performs print processing by forming an image on a paper sheet based on the received print data. The printer buffer 22 is formed by a random access memory (RAM) or the like and temporally stores the received image data. The printer communication unit 23 is a communication interface device that is composed of a network card, a USB port and the like, and connects between the printer 20 and other apparatuses (e.g., the scanner 10 and the host terminals 30). The printer controller 24 is composed of a central processor (CPU), various application specific integrated circuits (ASICs) and the like, and integrally controls the printer 20. The printer display 25 is a display device such as a liquid crystal display, and the printer operation unit 26 is an input device such as an operation button.

The printer buffer 22 stores image data transmitted from the scanner 10. As mentioned in the above, once image data of one page has been stored, the data is transferred to the engine 21 and the print processing is started.

According to the configuration described above, even if image data is sequentially sent from the scanner 10, the printer 20 will not start print operation until image data of one page has been stored. Therefore, if a copy-prohibited image is detected by the scanner 10, the print processing can be discontinued without printing the copy-prohibited image.

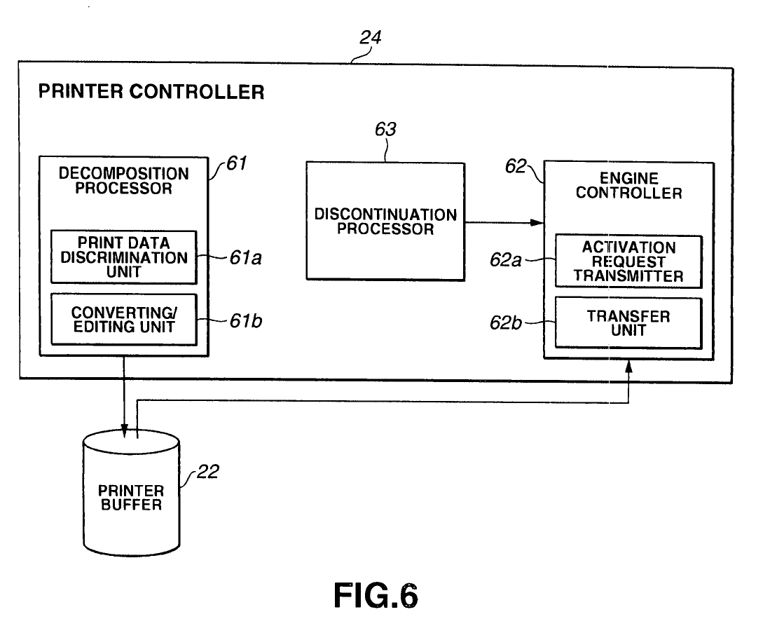

A description will now be made, with reference to FIG. 6, on a part of functional configuration of the printer controller 24.

The printer controller 24 includes, as processing functional units, a decomposition processor 61, an engine controller 62, and a discontinuation processor 63.

The decomposition processor 61 functions to interpret the page description language in the print data received via the printer communication unit 23 and to convert the print data into a bitmapped image, and is provided with a print data discrimination unit 61a and a converting/editing unit 61b.

The print data discrimination unit 61a analyzes the received print data to determined whether the print data is transmitted from the scanner 10 or from the host terminal 30. This determination is made by referring to the header written in the page description language in the print data to identify the data originating terminal.

The converting/editing unit 61b not only interprets the page description language in the print data to convert the print data into bitmapped image, but also performs, on the bitmapped image, image edit processing such as enlargement, reduction, or rotation. Since the print data sent from the scanner 10 contains image data formed by a bitmapped image, the bitmapped image is basically extracted directly from the print data. However, in some cases, the bitmapped image is again subjected to image edit processing such as reconversion.

The engine controller 62 not only transfers the image data to the engine 21 but also sends a control signal to control the print processing performed by the engine 21. The engine controller 62 is provided with an activation request transmitting unit 62a and a transfer unit 62b.

The activation request transmitting unit 62a transmits an activation request to the engine 21 to cause the same to start print preparation. Upon receiving the activation request, the engine 21 shifts to the printable state, for example, by energizing a heater to heat the fuser unit to a certain temperature or higher.

The transfer unit 62b functions to transfer image data to the engine 21. Upon lapse of a predetermined time (print preparation time) after the transmission of the activation request, the transfer unit 62b starts transferring image data to the engine 21. The print preparation time should be set at a value that is required by the engine 21 to shift to the state in which printing is possible. The print preparation time is thus preset at an appropriate value according to the performance of the engine 21.

The discontinuation processor 63 terminates the print processing of the printer 20 when receiving a termination code sent from the scanner 10. More specifically, the discontinuation processor 63 discards the image data stored in the printer buffer 22. In some cases, the discontinuation processor 63 may instruct the engine controller 62 to terminate the printing operation of the engine 21. The foregoing is the description of the function blocks showing a part of the functional configuration of the printer controller 24.

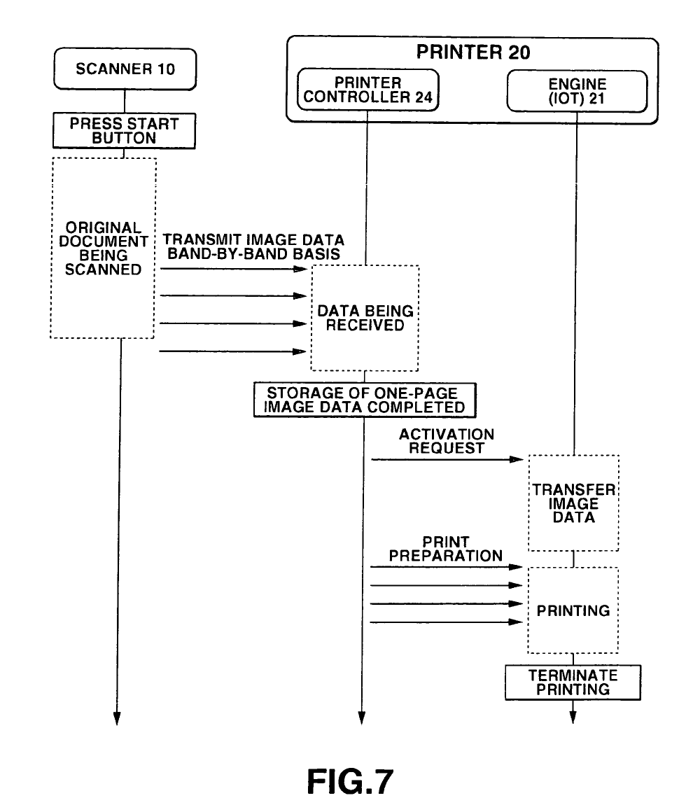

FIG. 7 is a sequence chart diagram showing an example of the processing steps of the print system shown in FIG. 1.

Firstly, on the scanner 10 side, an original document to be scanned is set and the start button is pressed, whereby the scan processing of the original document is started. Upon starting of the scan processing, line data is read from the original document and sequentially stored in the scanner buffer 13. Once image data of one band has been stored in the scanner buffer 13, the scanner 10 starts the transmission of the print data to the printer 20.

This transmission processing of the print data is performed every time image data of one band has been stored in the scanner buffer 13, and the print data contains the image data of one band. Along with the storage processing of the image data in the scanner buffer 13, the scanner 10 also performs pattern recognition at every predetermined number of lines to detect any copy-prohibited image.

On the printer 20 side, when print data is received via the printer communication unit 23, the printer controller 24 extracts image data (bitmapped image) from the print data and stores the same in the printer buffer 22. Once image data of one page has been stored in the printer buffer 22, the printer controller 24 transmits an activation request to the engine 21. Upon the transmission of the activation request, the printer controller 24 assumes the standby state until the print preparation time elapses.

Upon receiving the activation request, the engine 21 is triggered by the activation request to start print preparation. For example, the engine 21 starts energizing the heater to heat the fuser unit up to a specific temperature or higher so that the printer 20 is shifted to the state in which printing is possible.

Once the print preparation time has elapsed (print preparation of the engine 21 has been completed), the printer controller 24 starts transferring the image data to the engine 21. The engine 21 starts print processing by forming an image on a paper sheet based on the image data. The processing is terminated upon completion of the printing.

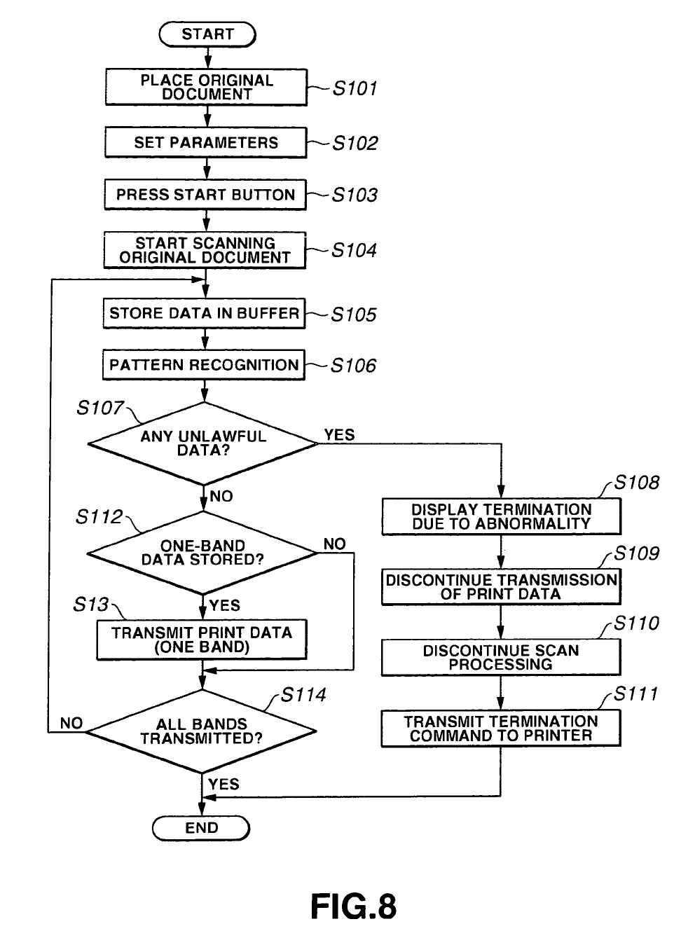

FIG. 8 is a flowchart showing an example of operation of the scanner 10 shown in FIG. 1.

When the user has placed an original document to be scanned on the platen glass or on the automatic paper feeder 11a (step S101), set the print parameters (step S102), and pressed the start button, the scan processing of the original document is started (step S104).

Upon the start of the scan processing, line data read by the image reader 12 from the original document is sequentially input into the PreIPS processor 51. After being subjected to predetermined data correction processing by the PreIPS processor 51, the line data is input to the IPS processor 52 and the pattern matching processor 54.

The line data, that has passed through the IPS processor 52 and so on to be subjected to predetermined image edit processing, is stored in the scanner buffer 13 (step S105). On the other hand, the pattern matching processor 54 performs pattern recognition on the received line data (step S106) to determine whether or not the line data contains any unlawful data (step S107).

If any unlawful data is detected (YES in step S107), the abnormality processor 55 abnormally terminates the copy processing that is being executed by the scanner 10 and the printer 20.

In this abnormality processing, the abnormality processor 55 firstly displays a message indicating the abnormality on the scanner display 15 (or generates an alarm sound). At the same time, the abnormality processor 55 discontinues the transmission of print data by the transmission controller 56 and the scan processing by the image reader 12 to abnormally terminate the scanner 10 (step S109 and step S110). The abnormality processor 55 also transmits a termination code to the printer 20 (step S111) to terminate the print processing that is being executed by the printer 20. This abnormality processing is then terminated.

If no unlawful data is detected in step S107 (NO in step S107) and image data of one band has been stored in the scanner buffer 13 (step S112), the transmission data generator 53 acquires the image data of one band stored in the scanner buffer 13, and generates print data written in a predetermined page description language. The transmission controller 56 transmits this print data to the printer 20 via the scanner communication unit 23 (step S113).

The above-described processing steps from step S105 to step S113 are repeated until completion of transmission of all the bands of data (NO in step S114). Upon completion of the transmission of all the bands of data (YES in step S114), this processing is terminated.

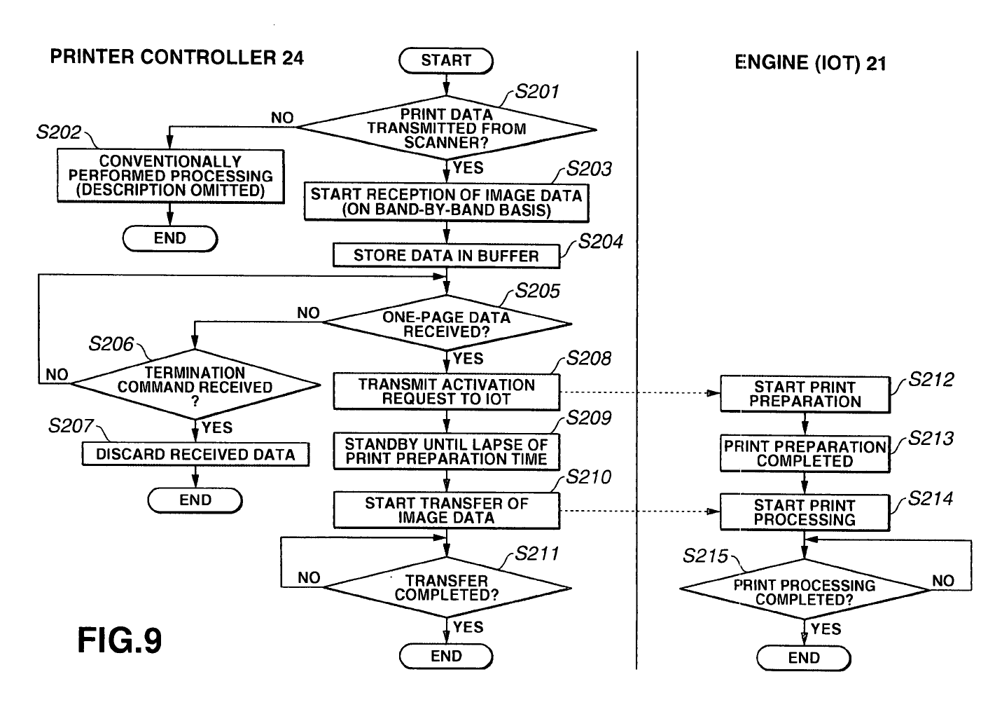

FIG. 9 is a flowchart showing an example of operation of the printer 20 shown in FIG. 1.

Upon receiving print data via the printer communication unit 22, the printer 20 analyzes the data to determine, by the print data discrimination unit 61a, whether the print data has been transmitted from the scanner 10 or from the host terminal 30 (step S201). As described before, this determination is performed by referring to the header written in the page description language in the print data to identify the originating terminal.

If it is determined that the print data has been transmitted from the host terminal 30 (NO in step S201), a conventionally known processing is performed, the description of which is omitted here (step S202), and the processing is terminated. In contrast, if it is determined that the print data has been transmitted from the scanner 10 (YES in step S201), the printer 20 sequentially receives the print data containing image data on a band-by-band basis (step S203), while extracting image data formed by a bitmapped image from the image data to store the extracted data in the printer buffer 22 (step S204). This processing is repeated continuously as long as print data is transmitted to the printer 20.

If the printer 20 receives a termination code from the scanner 10 before image data of one page is stored in the printer buffer 22 (NO in step S205 and then YES in step S206), the printer 20 discontinues the print processing (step S207). Since the print processing by the engine 21 has not been started yet at this point of time, the discontinuation processor 63 discards the received data only.

Once image data of one page has been stored in the printer buffer 22 (YES in step S205), the printer controller 24 transmits an activation request through the activation request transmitting unit 62a (step S208) to activate the engine 21. The printer controller 24 then assumes the standby state until the print preparation time lapses (step S209).

On the other hand, upon receiving the activation request, the engine 21 is triggered by the activation request to start print preparation (step S212) and is shifted to the state in which printing is possible (step S213).

The printer controller 24 starts transferring the image data through the transfer unit 62b upon lapse of the print preparation time (step S210). When the transfer is started, the engine 21 starts print processing by forming an image on a recording medium such as a paper sheet based on the image data (step S214).

When the data transfer from the printer controller 24 is completed (YES in step S211), the processing on the side of the printer controller 24 is terminated. The processing on the side of the engine 21 is also terminated once the print processing on the transferred data is completed (YES in step S215).

According to the present invention as described in the above, the scanner 10 reads line data from an original document while storing the read data in the scanner buffer 13. Simultaneously, the scanner 10 performs pattern recognition on the image data to detect any copy-prohibited image. Once image data of one band has been stored in the buffer, the scanner starts transmitting the image data (print data) to the printer 20. This configuration makes it possible to rapidly transmit image data from the scanner 10, and to prevent a copy-prohibited image from being copied.

If a copy-prohibited image is detected by the pattern recognition performed by the scanner 10, the copy processing that is being executed by the scanner 10 and the printer 20 is discontinued. Therefore, unlawful copying can be prevented effectively.

Although the above description of the embodiment has been made in terms of a case in which the printer 20 is a laser printer, the printer 20 need not necessarily be a laser printer, and may be any other type of printer (e.g., an ink-jet printer).

It should be understood that the present invention is not limited to the embodiment as described above and illustrated in the attached drawings, but may be otherwise variously embodied within the spirit and scope of the invention.

According to the present invention, image data read from an original document is sequentially stored in a buffer on a line-by-line basis, while pattern recognition is simultaneously performed on the image data to detect a copy-prohibited image. Once the image data corresponding to a predetermined number of lines of data has been stored in the buffer, transmission of the image data to the printing apparatus is started. If a copy-prohibited image is detected, the transmission of the image data is discontinued, while at the same time the printing apparatus is instructed to discontinue the print processing for the image data. Thus, according to the present invention, it is possible to transmit the image data rapidly from the image reading apparatus and to effectively prevent a copy-prohibited image from being copied.

The image reading apparatus and control method therefor according to the present invention are applicable to print systems in general which are provided with an image reading apparatus and a printing apparatus. In particular, according to the present invention, print (copy) processing can be performed by an inexpensive configuration in cooperation between the image reading apparatus and printing apparatus, and hence the present invention are effectively applicable in offices or departments where copying is done frequently.

As described above, according to an aspect of the present invention, an image reading apparatus that reads image data from an original document and transmits the read image data to a printing apparatus after writing the same in a predetermined page description language, the image reading apparatus comprises an image reader that reads image data from the original document on a line-by-line basis; a buffer that stores the image data read by the image reader sequentially on a line-by-line basis; a matching processor that performs pattern recognition at the same time with the storing of the image data in the buffer to detect a copy-prohibited image; a transmission controller that starts transmitting the image data to the printing apparatus upon completion of the storing of the image data of a predetermined number of lines in the buffer; an abnormality processor that, when the copy-prohibited image is detected by the matching processor, discontinues the transmission processing by the transmission controller, while simultaneously instructing the printing apparatus to discontinue the print processing for the copy-prohibited image.

According to another aspect of the present invention, when the copy-prohibited image is detected by the matching processor, the abnormality processor may discontinue the reading processing by the image reader, while simultaneously deleting the image data stored in the buffer.

According to still another aspect of the present invention, when the copy-prohibited image is detected by the matching processor, the abnormality processor may inform the detection.

According to yet another aspect of the present invention, a control method for an image reading apparatus that reads image data from an original document and transmits the read image data to a printing apparatus after writing the same in a predetermined page description language, comprises reading image data from the original document by an image reader; storing the image data read by the image reader in a buffer sequentially on a line-by-line basis; performing, at the same time with the storing of image data in the buffer, pattern recognition on the image data by a matching processor to detect a copy-prohibited image; starting transmission of image data to the printing apparatus by a transmission controller upon completion of the storing of the image data of a predetermined number of lines in the buffer; and discontinuing, if a copy-prohibited image is detected by the matching processor, the transmission processing by the transmission controller by an abnormality processor, while simultaneously instructing the printing apparatus to discontinue the print processing for the copy-prohibited image.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2005-238396 filed on Aug. 19, 2005 including specification, claims, drawings and abstract is incorporated herein by reference in its entirety

What is claimed is:

1. An image reading apparatus that reads image data from an original document and transmits the read image data to a printing apparatus after writing the same in a predetermined page description language, the image reading apparatus comprising:
an image reader that reads image data from the original document on a line-by-line basis;
a buffer that stores the image data read by the image reader sequentially on a line-by-line basis;
a matching processor that performs pattern recognition at the same time with the storing of the image data in the buffer to detect a copy-prohibited image;
a transmission controller that starts transmitting the image data to the printing apparatus upon completion of the storing of the image data of a predetermined number of lines in the buffer;
an abnormality processor that, when the copy-prohibited image is detected by the matching processor, discontinues the transmission processing by the transmission controller, while simultaneously instructing the printing apparatus to discontinue the print processing.

2. The image reading apparatus according to claim 1 wherein, when the copy-prohibited image is detected by the matching processor, the abnormality processor discontinues the reading processing by the image reader, while simultaneously deleting the image data stored in the buffer.

3. The image reading apparatus according to claim 1 wherein, when the copy-prohibited image is detected by the matching processor, the abnormality processor informs the detection.

4. A control method for an image reading apparatus that reads image data from an original document and transmits the read image data to a printing apparatus after writing the same in a predetermined page description language, the control method comprising:
reading image data from the original document by an image reader;
storing the image data read by the image reader in a buffer sequentially on a line-by-line basis;
performing, at the same time with the storing of image data in the buffer, pattern recognition on the image data by a matching processor to detect a copy-prohibited image;
starting transmission of image data to the printing apparatus by a transmission controller upon completion of the storing of the image data of a predetermined number of lines in the buffer; and
discontinuing, if a copy-prohibited image is detected by the matching processor, the transmission processing by the transmission controller by an abnormality processor, while simultaneously instructing the printing apparatus to discontinue the print processing.
